(19) United States
(12) Patent Application Publication
(10) Pub. No.: US 2019/0012405 A1
(43) Pub. Date: Jan. 10, 2019

(54) UNSUPERVISED GENERATION OF KNOWLEDGE LEARNING GRAPHS

(71) Applicant: International Business Machines Corporation, Armonk, NY (US)

(72) Inventors: Danish CONTRACTOR, Haryana (IN); Ravindranath KOKKU, Yorktown Heights, NY (US); Mukesh Kumar MOHANIA, New Delhi (IN); Nitendra RAJPUT, Haryana (IN)

(21) Appl. No.: 15/645,719

(22) Filed: Jul. 10, 2017

(51) Int. Cl. G06F 17/30

(52) U.S. Cl. CPC G06F 17/30958; G06F 17/30011; G06F 17/30554

(57) ABSTRACT

Method and apparatus for generating a knowledge graph. A first electronic document is received and each of a plurality of portions of the first electronic document is categorized as one of i) an introduction section and ii) a theory section, according to a rhetorical structure theory (“RST”) scheme. A first glossary of terms for the first document is determined. The knowledge graph containing a first plurality of nodes is generated, where each of the first plurality of nodes corresponds to a respective term from the first glossary of terms, and where a first edge between a first node corresponding to a first term and a second node corresponding to a second term is created based on determining that the first term appears within at least one introduction section and that the first term and the second term appears together within at least one theory section.

### BACKGROUND

The present application relates generally to data processing, and more specifically to unsupervised learning techniques for generating a knowledge graph from a document.

Natural language processing (NLP) is a field of computer science, artificial intelligence, and linguistics concerned with the interactions between computers and human (natural) languages. As such, NLP is often involved with natural language understanding, i.e., enabling computers to derive meaning from human or natural language input, and natural language generation.

NLP mechanisms generally perform one or more types of lexical or dependency parsing analysis including morphological analysis, syntactical analysis or parsing, semantic analysis, pragmatic analysis, or other types of analysis directed to understanding textual content. In morphological analysis, the NLP mechanisms analyze individual words and punctuation to determine the part of speech associated with the words. In syntactical analysis or parsing, the NLP mechanisms determine the sentence constituents and the hierarchical sentence structure using word order, number agreement, case agreement, and/or grammars. In semantic analysis, the NLP mechanisms determine the meaning of the sentence from extracted clues within the textual content. With many sentences being ambiguous, the NLP mechanisms may look to the specific actions being performed on specific objects within the textual content. Finally, in pragmatic analysis, the NLP mechanisms determine an actual meaning and intention in a given context (e.g., in the context of the speaker, in the context of the of previous sentence, etc.). These are only some aspects of NLP mechanisms. Many different types of NLP mechanisms exist that perform various types of analysis to attempt to convert natural language input into a machine understandable set of data.

Modern NLP algorithms are based on machine learning, especially statistical machine learning. The paradigm of machine learning is different from that of most prior attempts at language processing in that prior implementations of language-processing tasks typically involved the direct hand coding of large sets of rules, whereas the machine-learning paradigm calls instead for using general learning algorithms (often, although not always, grounded in statistical inference) to automatically learn such rules through the analysis of large corpora of typical real-world examples. A corpus (plural, “corpora”) is a set of documents (or sometimes, individual sentences) that have been hand-annotated with the correct values to be learned.

### SUMMARY

Embodiments of the present disclosure provide a method, system and computer-readable storage medium for generating a knowledge graph (also referred to herein as a concept graph). The method, system and computer-readable storage medium include receiving a first document. Additionally, the method, system and computer-readable storage medium include categorizing each of a plurality of portions of the first document as one of i) an introduction section and ii) a theory section, according to a Rhetorical Structure Theory (“RST”) scheme. The method, system and computer-readable storage medium also include determining a first glossary of terms for the first document. The method, system and computer-readable storage medium further include generating the knowledge graph containing a first plurality of nodes, where each of the first plurality of nodes corresponds to a respective term from the first glossary of terms, and where a first edge between a first node corresponding to a first term and a second node corresponding to a second term is created based on determining that the first term appears within at least one introduction section and that the first term and the second term appear together within at least one theory section. One embodiment also includes having the generated knowledge graph facilitate an automatic generation of subject matter based on proficiency level in a computer-based learning environment.

### BRIEF DESCRIPTION OF THE SEVERAL VIEWS OF THE DRAWINGS

FIG. 1 depicts a high level Rhetorical Structure Theory process for parsing document text and creating a knowledge graph in accordance with at least one embodiment.

FIG. 2 depicts a computer system that includes a learning graph generation component in accordance with at least one embodiment.

FIG. 3 depicts at least one block of text characterized per a Rhetorical Structure Theory using the learning graph generation component of FIG. 2.

FIG. 4 depicts at least two node learning graphs, which are optionally merged into a single graph, in accordance with an embodiment.

FIG. 5A depicts a plurality of introduction or glossary terms represented as nodes in a plurality of node graphs, in accordance with an embodiment.

FIG. 5B depicts a merged node graph in accordance with an embodiment.

FIG. 5C depicts a merged node graph in accordance with an embodiment.

FIG. 6 depicts a flow chart for creating a node knowledge graph in accordance with an embodiment.

FIG. 7 depicts a flow chart for creating a node knowledge graph in accordance with an embodiment.

FIG. 8 depicts a flow chart for creating a node knowledge graph in accordance with an embodiment.

### DETAILED DESCRIPTION

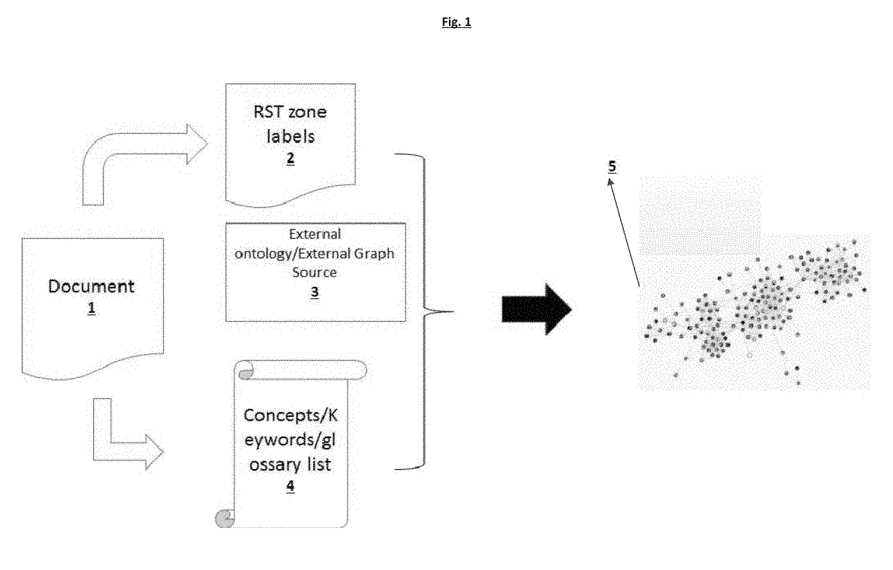

Various embodiments described herein provide systems and techniques for creating a learning graph to enable a knowledge presentation system. At a high level, as represented in FIG. 1, a document 1 is parsed by a natural language system configured with a rhetorical structure component, and the document is categorized into a plurality of rhetorical structure zones 2, where the system will identify a glossary of terms based on a pre-defined set of terms or by using automated operations, such as key-phrase extraction, on a block of text to extract the pre-supplied terms, and where rhetorical structure zones will enable the natural language system to determine if a relationship exists between or among the pre-supplied terms. If such a relationship exists, then the terms are an identified glossary of terms 4. The glossary of terms will in turn be used by a graph generating component of a system to create a knowledge graph 5 that reveals the hierarchy of data, and the terms or subjects that underlie the knowledge graph. The knowledge graph 5 will have nodes and links associated with the terms and the relationship of those terms, based on the glossary of terms, where some of the terms may not be immediately related. In certain embodiments, a system can categorize information (e.g., electronic documents) to improve the functionality of automated tutors and other computer devices. For example, the determined categories can be used to link information that is not immediately related, and to develop a knowledge path for a user that is struggling with a particular subject or set of subjects. The system can computationally perform this at a greater scale, automatically, and with greater proficiency than conventional techniques. In one embodiment, the knowledge presentation system can employ an external source 3 to create the knowledge graph 5, where the external source can be another node-graph, according to a different categorization tree, or any other suitable categorization scheme.

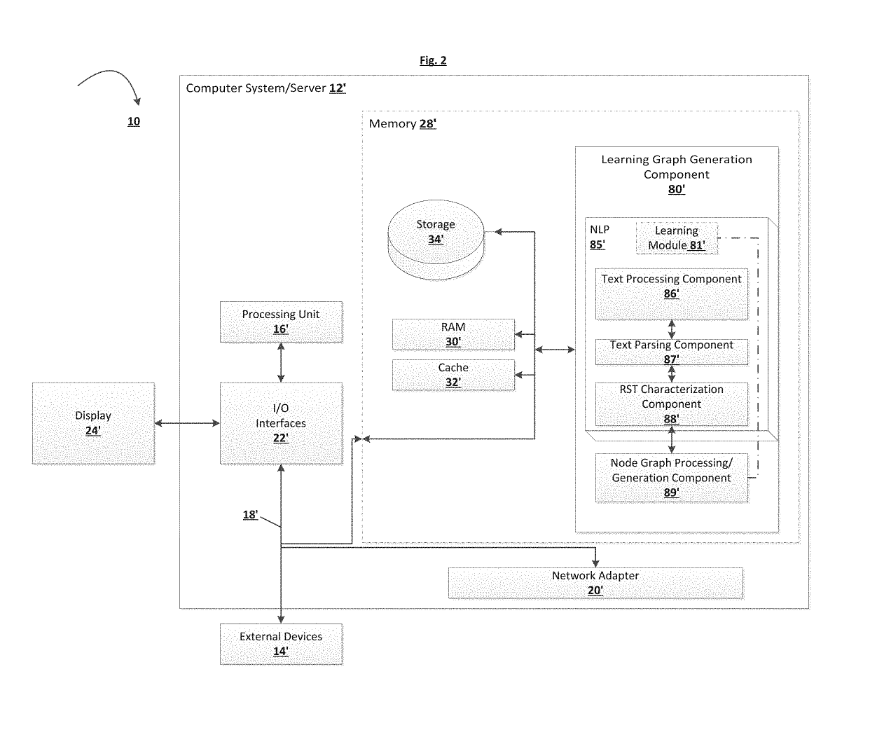

FIG. 2 illustrates a computer system that includes a learning graph generation component in accordance with at least one embodiment. As shown, the system 10 includes a computer system, such as a cloud computing node or server, 12′, which is operational with numerous other computing system environments or configurations. Examples of computing systems, environments, and/or configurations that may be suitable for use with computer system 12′ include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12′ may be configured with computer system-executable instructions, such as program modules, that are executable by the computer system 12′. Generally, program modules may include routines, programs, objects, components, logic, data structures, and so on that perform particular tasks or implement particular abstract data types. Computer system/server 12′ may be practiced in distributed cloud computing environments where tasks are performed by remote processing devices that are linked through a communications network. In a distributed cloud computing environment, program modules may be located in both local and remote computer system storage media including memory storage devices.

As shown, the system 12′ includes at least one processor or processing unit 16′, a system memory 28′, and a bus 18′ that couples various system components including system memory 28′ to processor 16′.

Bus 18′ represents at least one of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12′ typically includes a variety of computer system readable media. Such media may be any available media that are accessible by computer system/server 12′, and include both volatile and non-volatile media, removable and non-removable media.

System memory 28′ can include computer system readable media in the form of volatile memory, such as random access memory (RAM) 30′ and/or cache memory 32′. Computer system/server 12′ may further include other removable/non-removable, volatile/non-volatile computer system storage media. By way of example only, storage system 34′ can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18′ by at least one data media interface. As will be further depicted and described below, memory 28′ may include at least one program product having a set (e. at least one) of program modules that are configured to carry out the functions of embodiments of the invention.

Computer system/server 12′ may also communicate with at least one external device 14′ such as a keyboard, a pointing device, a display 24′, etc.; at least one device that enables a user to interact with computer system/server 12; and/or any devices (e.g., network card, modem, etc.) that enable computer system/server 12′ to communicate with at least one other computing device. Such communication can occur via I/O interfaces 22′. Still yet, computer system/server 12′ can communicate with at least one network such as a local area network (LAN), a general wide area network (WAN), and/or a public network (e.g., the Internet) via network adapter 20′. As depicted, network adapter 20′ communicates with the other components of computer system/server 12′ via bus 18′. It should be understood that although not shown, other hardware and/or software components could be used in conjunction with computer system/server 12′. Examples include, but are not limited to: microcode, device drivers, redundant processing units, external disk drive arrays, RAID systems, tape drives, and data archival storage systems, etc.

The system memory 28′ can include a learning graph generation component 80′, which in turn includes a natural language processing (NLP) component 85′ and a node graph generation component 89′. The natural language processing component 85′ includes a text processing component 86′, a text parsing component 87′, and an RST characterization component 88′. It should be noted that the components of the learning graph generation component 80′ can be consolidated into a single or multiple components, provided that the specific functionalities with respect to the component 80′, as described below, are configured accordingly.

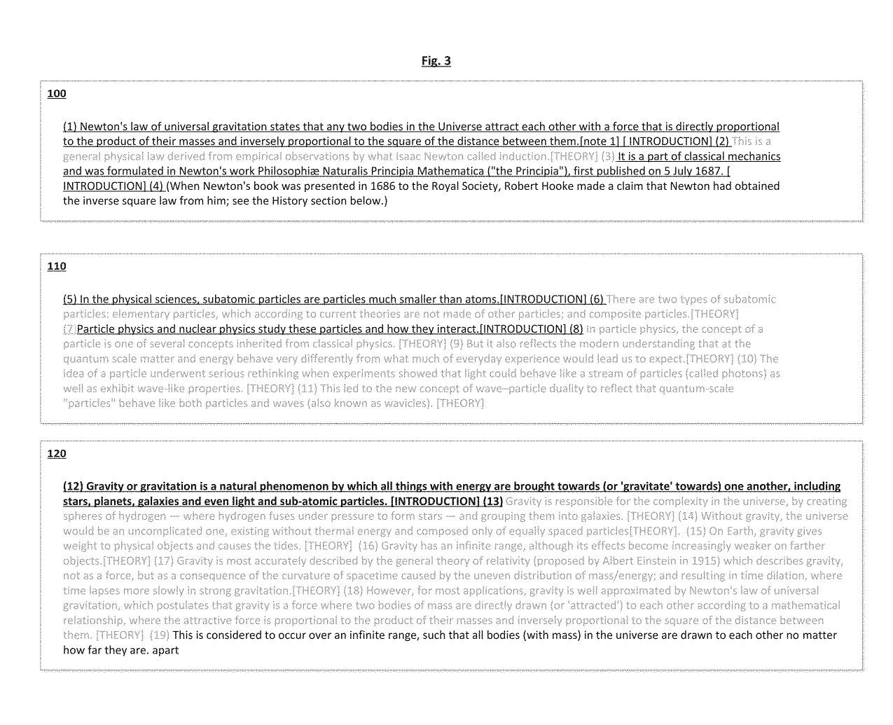

Referring to FIG. 3 in relation to FIG. 2, an exemplary set of texts 100 110 120 is received by the cloud compute node 10′ and processed by the NLP 85′. Specifically, the text processing component 86′ ingests the received information, i.e. text blocks 100 110 120, etc., and the text parsing component 87′ divides the text per the direction of the RST characterization component 88′. The RST characterization component 88′ is configured to apply at least one Rhetorical Structure Theory (“RST”) analysis to the text, and instructs the text parsing component to parse the text accordingly. In a broad sense, Rhetorical Structure Theory performs an analysis based on discourse relations of text spans, where discourse relations reveal a paratactic relationship or a hypotactic relationship. In one particular embodiment, the RST characterization component 88′ will divide, using electronic character recognition and analysis techniques, the individual text blocks into introduction zones, identified by solid black color and solid underlining in FIG. 3, and theory zones, identified by grey color in FIG. 3. An introduction zone refers to a zone where a particular item of interest is introduced in a text string, and a theory zone identifies text where the particular introduced item is being elaborated upon. A single block of text, i.e. 100, can have multiple theory zones covering one or more introduced items, and more than one introduction zone introducing separate items.

In one embodiment, the RST characterization component 88′ identifies, from a pre-supplied set of terms supplied by a user and located in memory 28′ or provided by the NLP 85′ using automated operations, such as key-phrase extraction, a plurality of glossary terms that stem from the introduction zones. A term can be identified as a term of interest by a user of the cloud computing node 10′ or the RST characterization component 88′ can identify a term as a relevant introduction term by i) detecting a discussion of the term in a subsequent portion of the incoming text, such as a theory zone, or ii) by detecting some other subject/object relationship that indicates that another portion of text depends on the term. Moreover, theory zones can form the basis for forming a link between introductory zones as discussed below.

In one embodiment, the RST characterization component 88′ labels each line of text and classifies each line as part of an introduction zone or a theory zone. The RST characterization component 88′ can also identify a particular term in an introduction zone as an introductory term, and it can also determine when one introductory term depends on or relates to another introductory term. The RST characterization component 88′ can identify a line in a block of text, i.e. 100 110 120, as an introductory zone or part of an introduction zone using any one of the following techniques i) automatically identifying a first line or sentence of a block of text, i.e. 100 110 120, as an introductory zone, ii) identifying a hypotactic relationship, such as a subject/object relationship, in a particular line, and then identifying that term of that hypotactic relationship, i.e. subject, discussed subsequently in another line of text, and/or iii) a line having a paratactic, i.e. coordinating, relationship between a line that meets conditions i) and/or ii), i.e. the subject of a first sentence of a block of text is used in a subsequent sentence to introduce or explain the subject of that subsequent sentence. The RST characterization component 88′ identifies an introductory term or glossary term as such if the term is a subject of an introductory zone and subsequently discussed in a theory zone. In one embodiment, The RST characterization component will further stipulate that the introductory terms or glossary terms are selected from a set of pre-defined terms provided by a user or system, in addition to meeting one of the preceding conditions. Finally, the RST characterization component 88′ identifies a line of text in a block of text, i.e. 100 110 120, as being a theory zone or part of a theory zone when that line i) discusses one or more introductory terms or glossary terms and/or ii) is a coordinating or paratactic relationship with an introductory zone sentence, i.e. the RST characterization component 88′ further develops a subject previously discussed in an introduction zone.

For example, FIG. 3 illustrates an example of a classification scheme pursuant to the above discussion. The RST characterization component 88′ identifies “Newton's law of gravitation” and “Universe” as the first introductory terms or glossary terms in the first sentence of text 100. The RST characterization component can identify the first two lines as an introduction zone because i) they constitute the first sentence of the block of text 100 or because ii) the term “Newton's law of gravitation,” which is a subject of the first sentence, is coordinated by the next sentence i.e. the next sentence expounds on the topic. The RST characterization component 88′ characterizes the next sentence as a theory zone because it further develops a subject of the preceding sentence, i.e. “Newton's law of gravitation.” Furthermore, the RST characterization unit 88′ determines that “Newton's law of gravitation” is an introductory term because it is a subject of the introductory zone and then discussed in at least one theory zone, i.e. the next sentence. “Universe” is similarly identified as an introduction term because it is a subject of the introductory zone and discussed in the theory zone beginning in line 13 located in text 110. In one embodiment, as discussed above, in addition to meeting the structural conditions discussed herein, the RST characterization unit 88′ will be configured with a pre-determined set of terms that can qualify as an introduction or glossary terms, and as such, in such an embodiment, “Universe” and “Newton's law of gravitation” could be part of that pre-defined set. Accordingly, per an embodiment, all of the introductory terms or glossary terms are compiled by the RST characterization component, following the aforementioned theme, and constitute a plurality of glossary terms that can be used to form a knowledge node graph, where the glossary of terms can be considered a single glossary of terms or multiple sets of glossary of terms, i.e. each associated with the text where it was first mentioned. In another embodiment, even terms that are part of the pre-defined set of terms, but are not identified as introductory terms or glossary terms based on the RST techniques discussed herein, will be identified as nodes by the RST characterization unit 88′, however, those terms will be disconnected from the rest of the nodes in a generated node graph.

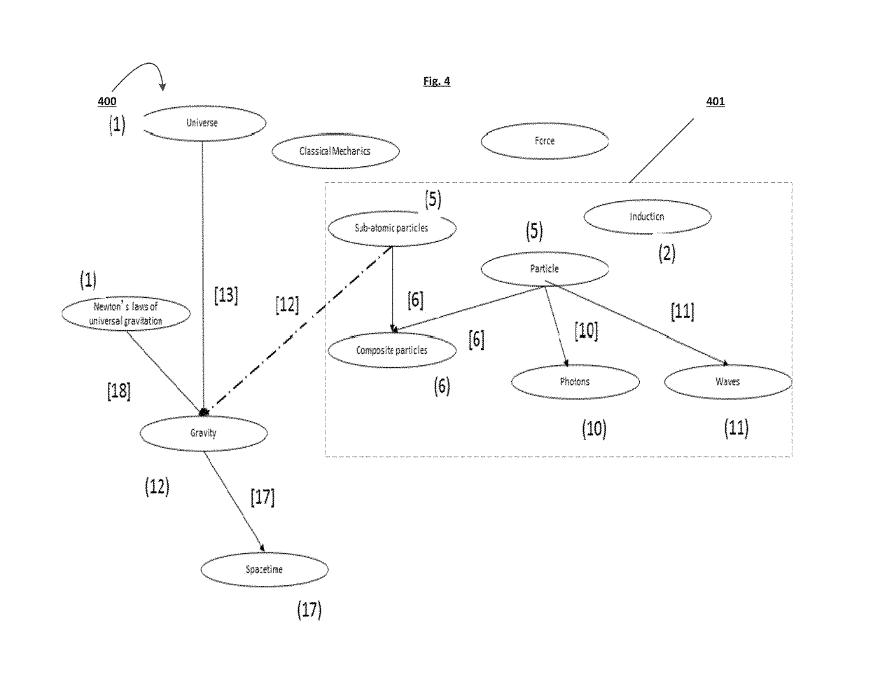

According to an embodiment, as depicted in FIG. 4 in relation to FIG. 3, the node graph generation component 89′ creates at least one knowledge node graph 400 based on the at least one RST characterization scheme as described above. Furthermore, according to this embodiment, the RST characterization component 88′ considers each line, and the position of the line, first, second, etc., of the texts 100 110 120 and labels relevant lines 1-19 as discussed herein. The glossary of terms will constitute all of the introduction terms, which in turn will each constitute a node within the node graph 400. The marking “( )” denotes the line in which the node or term is mentioned in the text. An edge is drawn between nodes when they are both discussed in a theory zone. The marking “[ ]” on the edges of the node graph denote at what line in the texts 100 110 120 the connected node terms were discussed together. For instance, “Universe” and “Gravity,” were discussed in the 12^{th} line located in text 110, and were introduced in the first and twelfth line, respectively, located in text 100; hence, the “(1)” marking associated with “Universe” and “(12)” associated with “Gravity, and the “[13]” mark associated with the edge connecting the two nodes. Unconnected terms, such as “Classical Mechanics” denote terms that were introduced and subsequently discussed, but were otherwise not discussed with another introductory term in a theory zone. In some embodiments, as discussed above, the unconnected terms can still be part of a pre-defined set of terms provided by a user, which the RST characterization component 88′ examines for an RST relationship as discussed herein. Accordingly, at least one node graph is generated by the node graph generation component, where the nodes represent introductory terms or glossary terms and the edges between nodes represent links of the terms being discussed together in at least one theory zone.

One implementation of at least one embodiment of the present disclosure by a system, such as an automated tutor, for assisting a user develop proficiency is described herein and below. A plurality of nodes generated by the node graph generation component 89′ pursuant to the RST categorization scheme of the RST categorization component 88′ can be a skill or term associated with a subject that a student or user has difficulty mastering or comprehending. The nodes themselves may have data embedded therein not only related to an RST scheme, but related to comprehension difficulty score, proficiency requirement, prerequisite skill, proficiency requirement for the prerequisite skill, and other such information. In one embodiment, determining the skill requirement may include identifying at least one term or skill as a prerequisite for the target.

According to an embodiment, the node graph generation component 89′ may communicate with the optionally include learning module 81′ depicted in FIG. 2. The learning module 81′ may identify that a student or user lacks proficiency in a particular topic. For example, the learning module 81′ can receive data, i.e. test results that demonstrate that a student or user does not understand the subject of “Newton's law of universal gravitation.” The learning module 81′ can coordinate with the node generation component 89′ to present subjects to the user based on the RST scheme generated node graph, i.e. as shown in FIG. 4. The node generation component 89′ can develop a knowledge path based on computing a proficiency of a specified number of nodes that are descendant or ancestor nodes of a node associated with a subject providing difficulty for the student, i.e. “Newton's law of gravitation.” The learning module 81′ can provide a threshold of mastery for each subject, before moving on to the next subject, and it can do this iteratively until a necessary mastery is reached for the original subject that requires proficiency by the user or student. Since the node graph is generated upon a textual discussion of subjects, the node graph and the techniques associated therewith offer an advantage over alternatives in that it is developed in a way that considers a natural discussion of terms and subjects, and thus improves the functionality of information presenting systems, such as automated tutors.

In one embodiment, the learning module 81′ may calculate a gap between the student or user proficiency and the target knowledge node based upon the identified knowledge path. The learning module can calculate this gap by associating a known value representing the student proficiency with a node representing a proficiency in the subject of the node or skill associated therewith. In addition, a required value may be associated with the node which represents a necessary proficiency needed to learn the target subject. The learning module may compare the two to determine the deficiency, if any, of the student or user. Based upon this calculation, the learning module 81′ may identify the requirements that a student must fulfill in order to reach the target proficiency in the subject or skill. These requirements may include the skills or concepts that a student needs to learn to complete a knowledge path.

According to an embodiment, as depicted in FIG. 4, a portion of the node graph 400 is, in actuality, a second node graph 401 connected to the rest of node graph 400. The node graph 401 is defined by the dotted line connecting gravity and sub-atomic particles. The dotted line signifies a sequential connection; where sequential means that the connection between the two nodes stems from one introductory term being introduced in the next line of the introductory term it connects to, i.e. line 5 and line 6. It is useful to identify sequential connections because those connections can be an indicator that nodes connected immediately following a certain relationship in a flow of text, and all proximate nodes, share a particular relationship, i.e. fall under the same category of thing; in the specific example of FIG. 4, the sequential relationship leads to a branch in the consolidated graph that shares the common theme of “particle.”

Accordingly, in certain embodiments, the node graph generation component 88′ forms a consolidated learning node graph from a first and second node graph, (which it also created), from a plurality introductory terms or glossary terms whose relationship is determined by an RST characterization component 88′ and according to an RST characterization scheme. It should be note that, in certain embodiments, component 88′ can perform any of the identification and annotation operations mentioned herein automatically and simultaneously, i.e. the node generation component 89′ can intake all text 100 110 120 identify the introduction zones and theory zones, and develop the plurality of glossary of terms in a non-linear fashion, as opposed to a human being and/or traditional computing device. This increases the scale at which information can be provided to the user, and allows for a faster identification of relationships between and amongst terms in a set of text in a manner that a human being or a traditional computer device would not be able to do.

In one embodiment, the consolidated node graph can be a pre-requisite knowledge graph, where a connection between two nodes indicates that a subject corresponding to one of the nodes is a pre-requisite for learning the second subject corresponding to the second node. In this instance, the learning module 81′ can present each subject associated with a term in the graph based on the node's, associated with the term, location in the graph, i.e. “particles,” presented first, then “protons,” etc. The learning module 81′ would move from subject to subject only once a specific mastery of a particular subject occurs.

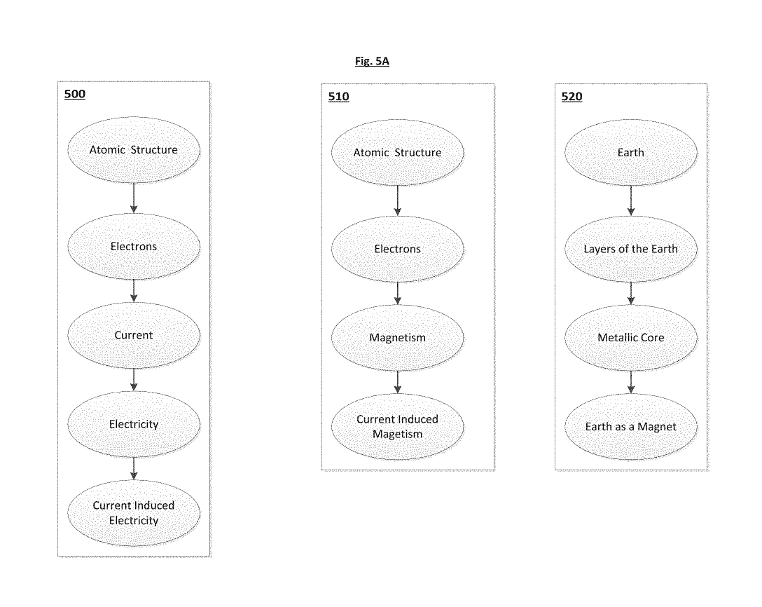

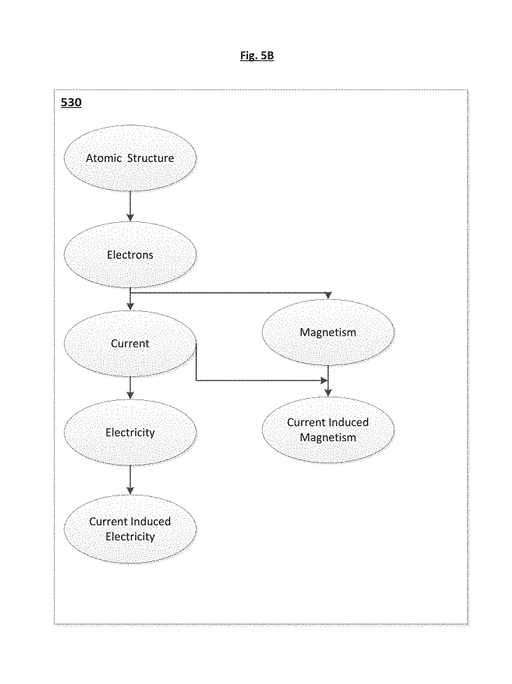

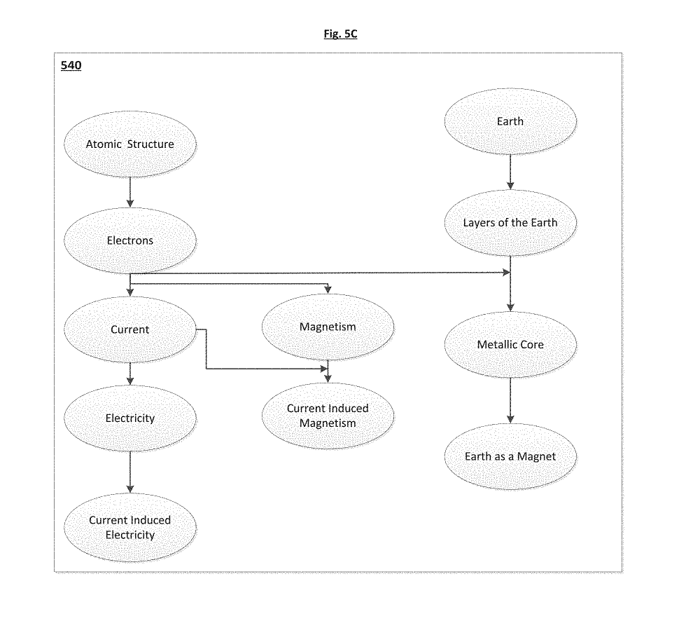

In another embodiment, according to FIG. 5A and FIG. 5B, an RST scheme is depicted. The RST characterization component 88′, per the techniques discussed above, can create three RST schemes (not shown) and identify three sets of introductory or glossary terms from the introductions zones of their respective texts (not shown). In turn, the node graph generation component 89′ can generate three node graphs from the plurality of glossary or introductory terms 500 510 520. Furthermore, the node graph generation component 89′ can link nodes of each of the respective graphs by identifying or computing the lowest common ancestor or ancestors of each graph and linking them at that point.

In terms of node classification as described in the present disclosure, an ancestor node can be a node upon which another node stems from, indirectly or directly, in the node-graph; for example, “Electrons” is an ancestor of “Electricity” in 530. In contrast, a descendant node is a node that stems from, directly or indirectly, from another node in a node graph, i.e. “Electricity” is a descendant of “Electrons” in the preceding example. Finally, a root node is a node of a node graph that does not have any ancestors, and a terminal node is a node that has no descendants, i.e. “Atomic Structure,” and “Currently Induced Electricity” respectively.

The computation for the lowest common ancestor can follow the basic scheme of making an N_c*N_d computation, where the number of nodes in a disconnected graph is N_d, and the total number of nodes in all currently connected graphs is N_c. With respect to FIG. 5 B, this means that a consolidated learning graph 530 from two sets of node graphs can be made by the node graph generation component 89′ by connecting and merging the graphs at the lowest common ancestor node “Electron.” With respect to FIG. 5C, it is evident that the graphs 500 510 530 do not share a common ancestor with graph 520. Accordingly, per another embodiment of the disclosure, the node graph generation component 89′ can ingest an external node categorization scheme, such as the Wikipedia® Category graph (Wikipedia® is a registered trademark of Wikimedia Foundation, Inc., a Florida non-profit corporation), to determine a pre-requisite node for at least one node in 520, such that the pre-requisite node is an ancestor node to at least one node in 530, and itself in turn has an ancestor in common with one of the graphs 500 510 520. In one embodiment, the external node categorization scheme can also serve as the basis for the pre-defined set of terms that the RST characterization component 88′ will receive to determine if an RST relationship exists. The graph 520 is linked to this determined ancestor node, which in turn is linked to node graph 530. The node graph generation component 89′ can determine the determined ancestor node by instructing the RST categorization component to perform an RST scheme on the external source, and then perform the lowest common ancestor computation on the applicable graphs, i.e. 520 530. In FIG. 5C, by way of example, the node graph generation component 89′ can determine, by consulting an external source, that “a metal object, such as a metallic core, can exhibit magnetism.” In encountering this text, the node graph generation component 89′ can link the graphs to form the final learning graph 540 as shown in FIG. 5C. Although not shown, in an embodiment, the node graph generation component 89′ can iterate the lowest ancestor computation until the consolidated graph 540 has a single root node.

In one embodiment, an automated tutor or other presentation system could employ the learning module 81′ to continuously assess the user or student's proficiency in a subject by employing the above scheme. The learning module 81′ could determine whether or not the user had proficiency on the subject based one threshold computation. If the user did not meet this threshold, then the learning module 81′ could employ generated RST categorization graphs to develop a knowledge path for the user. The node graph generation component 89′ could determine if the subject itself is a node in one of the node graphs. If it is a subject of one of the node graphs, then the node generation component 89′ can merge all graphs at the lowest common ancestor, and present the subjects associated with the chain of nodes, which contains the subject to be mastered by the user, to the user in a top down or bottom down fashion. The learning module 81′ could perform this iteratively until the user meets a threshold of mastery at a particular node in the chain, and then the learning module 81′ could proceed to the next node in the chain, and this could continue until the user achieved the level of mastery or proficiency required for the original subject of interest. This could more easily allow the automated system to present the user a topic he is comfortable with before proceeding to the descendant or ancestor node topics. As the user builds proficiency, the user can eventually be presented with the original subject node that provided the initial difficulty. Consequently, at least one embodiment of the present disclosure provides a substantial improvement to the technical field of automated learning by enabling an automated tutor to automatically and simultaneously obtain and present ancestor concepts, derived via an RST process employing RST natural language computer modules, that relate to subjects providing a difficulty to a user or student, where the presented ancestor concepts can help the student gradually obtain mastery of the more difficult subject stemming from those ancestor subjects.

In an embodiment, if the RST generated graphs did not have a common ancestor node, then the learning module 81′ could instruct the node graph generation component 89′ to obtain an external source categorization scheme, and reproduce the external categorization scheme in node format, where the external source node graph had at least one node that could be an ancestor node to a root node to one of the RST graphs, and where the external source graph could contain at least one node that could be an ancestor to a node representing the subject that the user must obtain mastery in. Linking the RST graphs, which have nodes based on terms that appear in texts and the relationships stem from text-based relationships that are suitable for human reading, to the external source node graph enables the learning module 81′ to present the RST subjects to the user for the purposes of establishing mastery of the original subject. This provides the substantial technical improvement as discussed in the preceding paragraph, with the additional improvement of being able to accommodate scenarios where the RST graphs do not have an immediately apparent relationship with a subject to be mastered by a user.

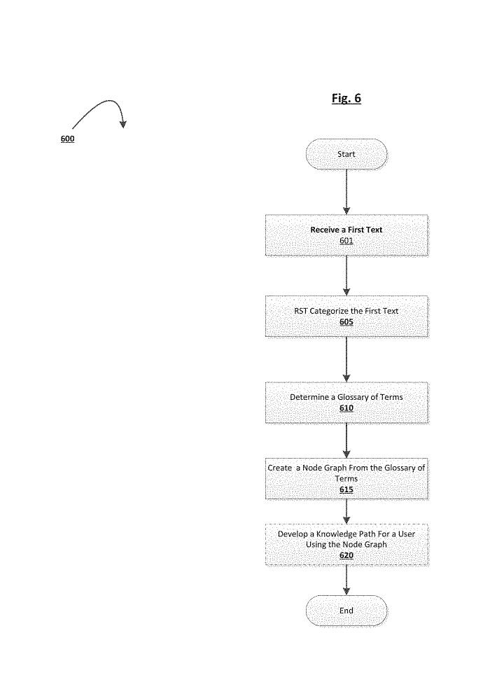

FIG. 6 illustrates a flow diagram 600 outlining an RST characterization scheme for creating a knowledge node graph in accordance with at least one embodiment. The NLP component 85′ of a cloud computing node 10′ receives at least one text input (i.e., electronic text data), such as a text block (i.e., block of electronic text), per block 601. Per block 605, the RST characterization component 88′ of the NLP component 85′ creates an RST characterization scheme that divides the text input into an introduction zone, where an item or term is introduced, and a theory zone where the item or term is elaborated on or otherwise evinces a dependent relationship thereto. In one embodiment, the RST characterization component will characterize, line-by-line, each line of the text input into either an introduction zone or a theory zone. An exemplary RST scheme with at least one text block is shown in FIG. 3. Per block 610, the RST characterization scheme identifies a glossary or introduction set of terms from the introduction zones, as having an RST relationship, which can then be used, per block 615, by the node graph creation component 89′ to create a node knowledge graph. The NLP component 85′ can receive a pre-supplied set of terms supplied by a user and located in memory 28′ or provided by the NLP 85′ using automated operations, such as key-phrase extraction, on a block of text, which is the set of terms that the RST characterization component will evaluate to determine whether or not a relationship, e.g. RST relationship, exists between one or more of those pre-supplied terms. In certain embodiments, in addition to meeting RST conditions as outlined above, the glossary or introductory terms must be part of a pre-configured set of terms in the RST characterization component 88′. An exemplary node knowledge graph (which can be considered two merged node knowledge graphs) is shown in FIG. 4. Optionally, per block 620, the resulting node knowledge graph can be employed by a learning module 81′ to develop a knowledge path for a user or student that requires proficiency with a subject associated with a node in the node graph. Specifically, the learning module 81′ will employ a set of criteria to determine a base line proficiency for a particular subject. If the user does not meet the specified base line criteria, the learning module 81′ will present subject matter to the user associated with nodes that are ancestors and/or descendants, within a certain edge range, of the subject node. The learning module 81′ can then assess the degree of proficiency with respect to the present subjects, and once a threshold is met, the learning module 81′ can have the user revisit the original subject that was giving the user difficulty. Since the node graph is generated upon a textual discussion of subjects, the node graph offers an advantage over alternatives in that it is developed in a way that considers a natural discussion of terms and subjects, and thus improves the computer functionality of information presenting systems, such as automated tutors.

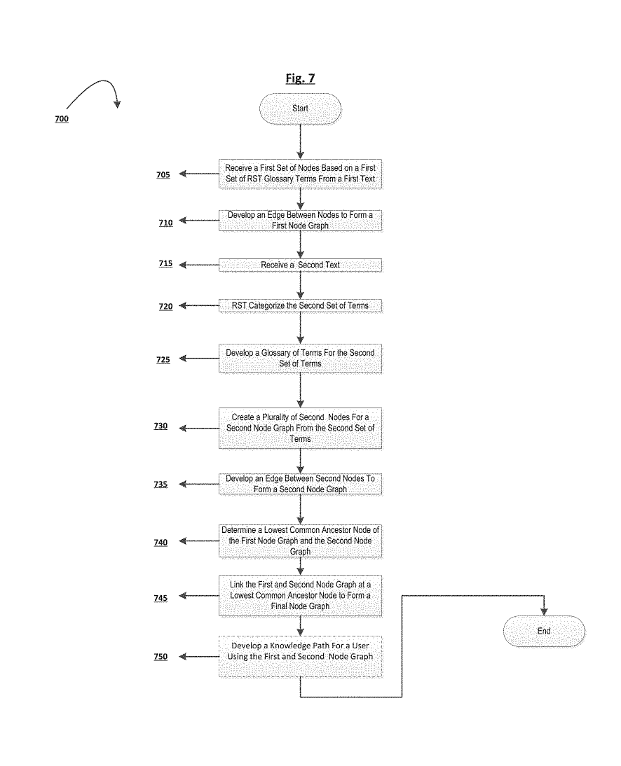

FIG. 7 illustrates a flow diagram 700 outlining an RST characterization scheme for creating a node graph in accordance with at least one embodiment. In step 705, the node graph creation component 89′ receives a set of nodes that are obtained from an RST scheme as discussed above, and in block 710, an edge is created between at least two of the plurality of nodes to develop a node graph, where the edge is based on an introduction and theory zone feature of an RST categorization made by the RST characterization component 88′ as discussed above. In blocks 715-735, the steps, as outlined for the above embodiments, are repeated for a second block of text to create a second node-graph. Namely, the NLP 85 receives a second block of text, the and the text parsing component 87′ divides the text per the direction of the RST characterization component 88′. The RST characterization component 88′ applies an RST scheme to the second text, i.e. categorizing the second text into an introduction zone(s) and theory zone(s), and obtains a set of introductory or glossary of terms from the RST scheme, per the techniques discussed above. The node graph generation component 89′ creates plurality of nodes from the glossary of terms or introduction terms provided by the RST characterization component 88′, and an edge is created between the plurality of nodes based on the RST characterization scheme, i.e. whether the terms associated with the node appear in a same theory zone, which forms the second node graph. Per block 740, the node graph generation component 89′ determines the lowest common ancestor of the two node graphs, and per block 745, the node generation component 89′ links the two graphs at the lowest common ancestor. In one embodiment, per block 705, an edge is created between at least two of the plurality of nodes to develop a node graph, where the edge is based on an introduction and theory zone feature of an RST categorization made by the RST characterization component 88′ as discussed above. Per block 710, the NLP component 85′ of a cloud computing node 10′ receives at least one text input with a second set of terms. In one embodiment, the first set of terms and the second set of terms are processed as a single RST characterization scheme by the RST characterization component 88′. For example, as discussed with respect to FIG. 3, three sets of text 100 110 120 are received, but per one embodiment, the RST characterization component considers the line designations for the introduction zones and theoretical zones as one when performing the RST characterization scheme, and the node graph generation component generates two node graphs which are merged into one graph, as is shown in FIG. 4. In another embodiment, per block 735, the node graph generation unit 89′ computes the lowest common ancestor node for the first and second plurality of nodes and merges them into a single graph at the lower common ancestor node, as depicted per block 740. An exemplary embodiment depicting the latter scheme is shown in FIG. 5B.

Optionally, per block 750, the resulting merged node knowledge graph can be employed by a learning module 81′ to develop a knowledge path for a user or student that requires proficiency with a subject associated with a node in the node graph. Specifically, the learning module 81′ will employ a set of criteria to determine a base line proficiency for a particular subject. If the user does not meet the specified base line criteria, the learning module 81′ will present subject matter to the user associated with nodes that are ancestors and/or descendants, within a certain edge range, of the subject node. The learning module 81′ can then assess the degree of proficiency with respect to the present subjects, and once a threshold is met, the learning module 81′ can have the user revisit the original subject that was giving the user difficulty. Since the node graph is generated upon a textual discussion of subjects, the node graph offers an advantage over alternatives in that the node graph is developed in a way that considers a natural discussion of terms and subjects, and thus improves the functionality of information presenting systems, such as automated tutors.

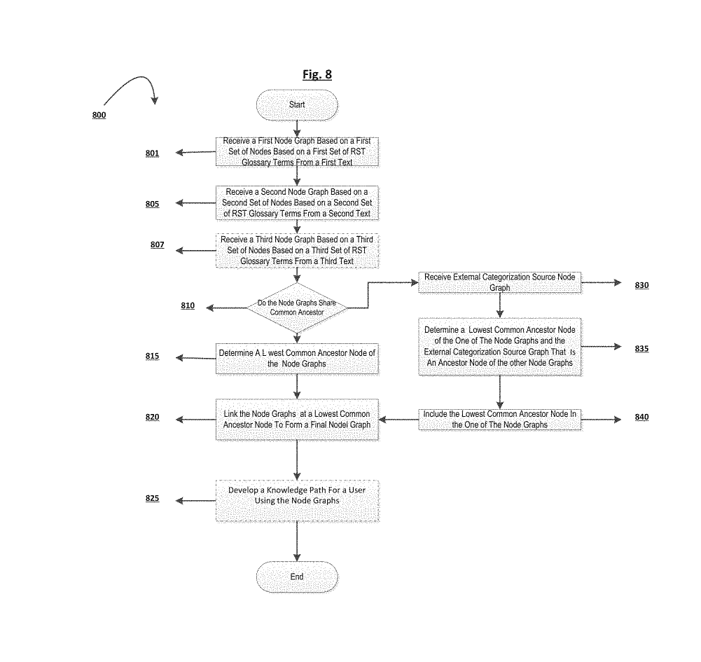

FIG. 8 illustrates a flow diagram 700 outlining an RST characterization scheme for creating a node graph in accordance with at least one embodiment. At blocks 801, 805, and 807 RST graphs are received by the node graph generation component 89′ in accordance with the RST schemes identified above. Per block 810, if the three graphs share at least lowest common ancestor node, then the process proceeds to block 815, 820, and optionally, 830. The node graph generation component 89′ determines the lowest common ancestor, and the three graphs are linked as one at that point, which can constitute, per one embodiment, as a linkage of three node graphs; an embodiment implementing this flow diagram is described in the discussion above with reference to FIG. 5C. If the three graphs do not possess a lowest common ancestor, then per block 830, the NLP component 85 receives at least one external source node graph. Per block 835, the node graph generation component 89′ determines a lowest common ancestor node that is common to the three node graphs and the external source node graph, which can be a considered a fourth node graph. Per block 840 the common lowest node will be included in one of the graphs, i.e. the first node graph, and then, per block 820, the four node graphs will be merged by the node graph generation component 89′. This allows the node generation component 89′ to include the lowest common ancestor node in the first node graph, and optionally, per one embodiment (although not shown), link the first node graph to the external source node graph.

Optionally, per block 825 the learning module 81′ will use the resultant merged graph to assist a user in obtaining mastery in a subject, as described in the discussion above.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the described aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to embodiments of the present invention, other and further embodiments of the invention may be devised without departing from the basic scope thereof, and the scope thereof is determined by the claims that follow.

What is claimed is:

1. A computer implemented method for generating a knowledge graph, comprising:
receiving a first electronic document;
electronically categorizing each of a plurality of portions of the first electronic document as one of i) an introduction section and ii) a theory section, according to a Rhetorical Structure Theory (RST) scheme;
determining a first glossary of terms for the first electronic document; and
generating the knowledge graph containing a first plurality of nodes, wherein each of the first plurality of nodes corresponds to a respective term from the first glossary of terms, the first plurality of nodes including a first node and a second node, the first node corresponding to a first term from the first glossary of terms and a second node corresponding to a second term from the first glossary of terms, and wherein a first edge between the first node and the second node is created based on determining, from the categorizing, that the first term appears within at least one introduction section and that the first term and the second term appear together within at least one theory section.

2. The method according to claim 1, wherein the determining the first glossary of terms further comprises:
receiving a set of terms from a user; and
upon determining that a third term within the set of terms is a subject of a sentence in the least one introduction section and upon further determining that the third term is discussed in the at least one theory section, adding the third term to the first glossary of terms.

3. The method according to claim 1, wherein the plurality of portions further comprise a plurality of sentences within the first electronic document.

4. The method according to claim 1, further comprising:
receiving a second electronic document;
electronically categorizing each of a plurality of portions of the second electronic document as one of i) an introduction section and ii) a theory section, according to the RST scheme;
determining a second glossary of terms for the second electronic document;
generating a second knowledge graph containing a second plurality of nodes, wherein each of the second plurality of nodes corresponds to a respective term from the second glossary of terms, and wherein edges between nodes in the second plurality of nodes are created upon determining that a third term appears within at least one introduction section within the second electronic document and that the third term appears together with a fourth term within at least one theory section of the second electronic document.

5. The method according to claim 4, further comprising:
determining a lowest-common ancestor node for the first knowledge graph and the second knowledge graph; and
forming a pre-requisite knowledge graph by linking the first knowledge graph and the second knowledge graph at the lowest-common ancestor node, wherein the pre-requisite knowledge graph is used by an automated tutor to develop a knowledge path for a user to obtain proficiency in a subject that is related to at least one node of the pre-requisite knowledge graph.

6. The method according to claim 5, further comprising:
receiving a third knowledge graph, wherein the third knowledge graph does not share any common ancestor node with the pre-requisite knowledge graph and is disconnected from the pre-requisite knowledge graph.

7. The method according to claim 6, further comprising:
receiving at least one external categorization source in node format;
determining a root node of the third knowledge graph that is a descendant node of at least one node of the external concept source graph, wherein the at least one node of the external concept source graph is a descendant node to at least one node of the pre-requisite knowledge graph;
including the determined lowest-common ancestor node of the pre-requisite graph and the external concept source graph in the pre-requisite graph;
determining a lowest-common ancestor node of the pre-requisite graph and the external concept source graph; and
forming a final knowledge graph by linking the third knowledge graph and the external source knowledge graph at the determined lowest-common ancestor node of the pre-requisite graph and the external concept source graph, wherein the third-node knowledge graph contains a node associated with another subject for obtaining proficiency in by the user.

8. A system, comprising:
one or more computer processors; and
a memory containing computer program code that, when executed by operation of the one or more computer processors, performs an operation for generating a knowledge graph, the operation comprising:
receiving a first electronic document;
categorizing each of a plurality of portions of the first document as one of i) an introduction section and ii) a theory section, according to a Rhetorical Structure Theory (“RST”) scheme;
determining a first glossary of terms for the first document; and
generating the knowledge graph containing a first plurality of nodes, wherein each of the first plurality of nodes corresponds to a respective term from the first glossary of terms, the first plurality of nodes including a first node and a second node, the first node corresponding to a first term from the first glossary of terms and a second node corresponding to a second term from the first glossary of terms, and
wherein a first edge between the first node and the second node is created based on determining, from the categorizing, that the first term appears within at least one introduction section and that the first term and the second term appear together within at least one theory section.

9. The system according to claim 8, wherein the determining the first glossary of terms further comprises:
receiving a set of terms from a user; and
upon determining that a third term within the set of terms is a subject of a sentence in the least one introduction section and upon further determining that the third term is discussed in the at least one theory section, adding the third term to the first glossary of terms.

10. The system according to claim 8, wherein the plurality of portions further comprise a plurality of sentences within the first electronic document.

11. The system according to claim 8, the operation further comprising:
receiving a second electronic document;
electronically categorizing each of a plurality of portions of the second electronic document as one of i) an introduction section and ii) a theory section, according to the RST scheme;
determining a second glossary of terms for the second electronic document;
generating a second knowledge graph containing a second plurality of nodes, wherein each of the second plurality of nodes corresponds to a respective term from the second glossary of terms, and wherein edges between nodes in the second plurality of nodes are created upon determining that a third term appears within at least one introduction section within the second electronic document and that the third term appears together with a fourth term within at least one theory section of the second electronic document.

12. The system according to claim 11, the operation further comprising:
determining a lowest-common ancestor node for the first knowledge graph and the second knowledge graph; and
forming a pre-requisite knowledge graph by linking the first knowledge graph and the second knowledge graph at the lowest-common ancestor node, wherein the pre-requisite knowledge graph is used by an automated tutor to develop a knowledge path for a user to obtain proficiency in a subject that is related to at least one node of the pre-requisite knowledge graph.

13. The system according to claim 12, the operation further comprising:
receiving a third knowledge graph, wherein the third knowledge graph does not share any common ancestor node with the pre-requisite knowledge graph and is disconnected from the pre-requisite knowledge graph.

14. The system according to claim 13, the operation further comprising:
receiving at least one external categorization source in node format;
determining a root node of the third knowledge graph that is a descendant node of at least one node of the external concept source graph, wherein the at least one node of the external concept source graph is a descendant node to at least one node of the pre-requisite knowledge graph;
including the determined lowest-common ancestor node of the pre-requisite graph and the external concept source graph in the pre-requisite graph;
determining a lowest-common ancestor node of the pre-requisite graph and the external concept source graph; and
forming a final knowledge graph by linking the third knowledge graph and the external source knowledge graph at the determined lowest-common ancestor node of the pre-requisite graph and the external concept source graph, wherein the third-node knowledge graph contains a node associated with another subject for obtaining proficiency in by the user.

15. A computer-readable storage medium containing computer program code that, when executed by operation of one or more computer processors, performs an operation comprising:
receiving a first electronic document;
electronically categorizing each of a plurality of portions of the first electronic document as one of i) an introduction section and ii) a theory section, according to a Rhetorical Structure Theory (“RST”) scheme;
determining a first glossary of terms for the first electronic document; and
generating the knowledge graph containing a first plurality of nodes, wherein each of the first plurality of nodes corresponds to a respective term from the first glossary of terms, the first plurality of nodes including a first node and a second node, the first node corresponding to a first term from the first glossary of terms and a second node corresponding to a second term from the first glossary of terms, and wherein a first edge between the first node and the second node is created based on determining, from the categorizing, that the first term appears within at least one introduction section and that the first term and the second term appear together within at least one theory section.

16. The computer-readable storage medium according to claim 15, wherein the determining the first glossary of terms further comprises:
receiving a set of terms from a user; and
upon determining that a third term within the set of terms is a subject of a sentence in the least one introduction section and upon further determining that the third term is discussed in the at least one theory section, adding the third term to the first glossary of terms.

17. The computer-readable storage medium according to claim 15, wherein the plurality of portions further comprise a plurality of sentences within the first electronic document.

18. The computer-readable storage medium according to claim 15, further comprising:
receiving a second electronic document;
electronically categorizing each of a plurality of portions of the second electronic document as one of i) an introduction section and ii) a theory section, according to the RST scheme;
determining a second glossary of terms for the second electronic document;
generating a second knowledge graph containing a second plurality of nodes, wherein each of the second plurality of nodes corresponds to a respective term from the second glossary of terms, and wherein edges between nodes in the second plurality of nodes are created upon determining that a third term appears within at least one introduction section within the second electronic document and that the third term appears together with a fourth term within at least one theory section of the second electronic document.

19. The computer-readable storage medium according to claim 18, further comprising:
determining a lowest-common ancestor node for the first knowledge graph and the second knowledge graph; and
forming a pre-requisite knowledge graph by linking the first knowledge graph and the second knowledge graph at the lowest-common ancestor node, wherein the pre-requisite knowledge graph is used by an automated tutor to develop a knowledge path for a user to obtain proficiency in a subject that is related to at least one node of the pre-requisite knowledge graph.

20. The computer-readable storage medium according to claim 19, further comprising:
receiving a third knowledge graph, wherein the third knowledge graph does not share any common ancestor node with the pre-requisite knowledge graph and is disconnected from the pre-requisite knowledge graph;
receiving at least one external categorization source in node format;
determining a root node of the third knowledge graph that is a descendant node of at least one node of the external concept source graph, wherein the at least one node of the external concept source graph is a descendant node to at least one node of the pre-requisite knowledge graph;
including the determined lowest-common ancestor node of the pre-requisite graph and the external concept source graph in the pre-requisite graph;
determining a lowest-common ancestor node of the pre-requisite graph and the external concept source graph; and
forming a final knowledge graph by linking the third knowledge graph and the external source knowledge graph at the determined lowest-common ancestor node of the pre-requisite graph and the external concept source graph, wherein the third-node knowledge graph contains a node associated with another subject for obtaining proficiency in by the user.
